(19) United States
(12) Patent Application Publication
(10) Pub. No.: US 2026/0362556 A1
(43) Pub. Date: Nov. 12, 2026

(54) METHOD FOR JOINING WORKPIECES

(71) Applicant: Paul Po CHENG, London (CA)

(72) Inventor: Paul Po CHENG, London (CA)

(21) Appl. No.: 19/673,110

(22) Filed: May 11, 2026

Related U.S. Application Data
(60) Provisional application No. 63/804,014, filed on May 12, 2025.

(51) Int. Cl. H05B 6/02; B23P 15/00

(52) U.S. Cl. CPC H05B 6/02; B23P 15/00

(57) ABSTRACT

The disclosure is directed at a method and system for joining workpieces that includes a predetermined material therebetween in order to improve the characteristics of the joint between the two workpieces.

### CROSS-REFERENCE TO OTHER APPLICATIONS

The disclosure claims priority from U.S. Provisional Application No. 63/804,014 filed May 12, 2025 which is hereby incorporated by reference.

### FIELD

The disclosure is generally directed at metallurgy and, more specifically, at a method for joining workpieces.

### BACKGROUND

As is well known in the art, metal workpieces (e.g. tubing, plates or rods) may be joined via solid state welding, however, one consequence of conventional welding methods is that the weld material that joins workpieces may have characteristics that significantly differ from those of the balance of the workpieces. For instance, the metal in and adjacent to the weld may include a “heat-affected zone” of material that has been melted during the welding process, but subsequently solidified, and as a result, the metal forming the weld may have different characteristics from the metal of the workpieces.

Currently, one way to attempt to address this issue is to add certain elements or compounds to the welded materials, when the weld is formed, to improve the characteristics of the welded material. In conventional arc welding, for example, certain elements or compounds that are selected for the properties they may impart to the weld might be included in the conventional welding electrode. Typically, the selected elements or compounds are intended to form alloys or compounds in the weld material, when the molten metal is put in place, that will have characteristics that address one or more specific disadvantages that would otherwise result from the conventional welding process.

### SUMMARY

For the foregoing reasons, there is a need for a method for joining workpieces that overcomes or mitigates one or more of the defects or deficiencies of the prior art.

In its broad aspect, the disclosure provides methods of joining a first workpiece and a second workpiece together at respective first and second ends thereof. In one embodiment, the method includes positioning the first and second workpieces a predetermined distance apart from each other to locate the respective first and second ends facing each other, defining a gap therebetween. One or more heating elements are positioned in the gap. With the heating elements, first and second heated portions of the first and second workpieces are heated in an inert atmosphere to a hot working temperature, at which the first and second heated portions are plastically deformable. The first and second heated portions extend from respective first and second end surfaces into the respective first and second workpieces. Once the heated portions are at the hot working temperature, the heating elements are removed from the gap.

Next, while the first and second heated portions are at the hot working temperature, a predetermined quantity of a preselected material is directed onto the respective first and second end surfaces.

While the first and second heated portions are at the hot working temperature, one or both of the first and second workpieces are subjected to a translocation motion, to engage the first and second end surfaces with each other. Also, while the first and second heated portions are at the hot working temperature, the first and second end surfaces are urged against each other.

While the first and second heated portions are at the hot working temperature, and while the first and second end surfaces are engaged, one or both of the first and second workpieces are subjected to an engagement motion, in which the one or both of the first and second workpieces are subjected to relative movement thereof, for metallurgically bonding the first and second workpieces together.

In one aspect of the disclosure, there is provided a method of joining a first workpiece and a second workpiece including positioning an end of the first workpiece and an end of the second workpiece a predetermined distance apart from each other, the end of the first workpiece and the end of the second workpiece defining a gap therebetween; heating respective first and second heated portions of the first and second workpieces, in an inert atmosphere, to their hot working temperature; while the first and second heated portions are at their hot working temperature, directing a predetermined quantity of a preselected material onto at least one of the end of the first workpiece and the end of the second workpiece; while the first and second heated portions are at their hot working temperature, subjecting one or both of the first and second workpieces to a translocation motion, to engage the end of the first workpiece with the end of the second workpiece with each other; and while the first and second heated portions are at their hot working temperature, and while the end of the first workpiece and the end of the second workpiece are engaged, subjecting one or both of the first and second workpieces to an engagement motion, in which said one or both of the first and second workpieces are subjected to relative movement thereof, for metallurgically bonding the first and second workpieces together.

In another aspect, heating respective first and second heated portions of the first and second workpieces, in an inert atmosphere, to their hot working temperature includes locating at least one heating element in the gap between the end of the first workpiece and the end of the second workpiece; and energizing the at least one heating element. In yet another aspect, heating respective first and second heated portions of the first and second workpieces, in an inert atmosphere, to their hot working temperature further includes removing the at least one heating element from the gap between the end of the first workpiece and the end of the second workpiece. In a further aspect, directing a predetermined quantity of a preselected material onto at least one of the end of the first workpiece and the end of the second workpiece includes directing particles of the preselected material at at least one end of the first workpiece and the end of the second workpiece. In an aspect, directing a predetermined quantity of a preselected material onto at least one of the end of the first workpiece and the end of the second workpiece includes directing a coating at at least one of the end of the first workpiece and the end of the second workpiece. In another aspect, directing a coating at at least one of the end of the first workpiece and the end of the second workpiece includes directing the coating at inner surfaces of at at least one of the first or second workpieces. In yet a further aspect, directing the coating at inner surfaces of at at least one of the first or second workpieces includes directing the coating at first and second heated portions of the first and second workpieces. In yet another aspect, after subjecting the first and second workpieces to the translation motion, urging the end of the first workpiece and the end of the second end workpieces each other. In another aspect, the engagement motion is a rotational motion.

### BRIEF DESCRIPTION OF THE DRAWINGS

The disclosure will be better understood with reference to the attached drawings, in which:

FIG. 1 is a longitudinal section of first and second workpieces, with a heating element positioned therebetween;

FIG. 2 is a longitudinal section of the two workpieces of FIG. 1, with devices for directing preselected material onto respective first and second end surfaces of the first and second workpieces;

FIG. 3 is a longitudinal section of the first and second workpieces of FIGS. 1 and 2 in which the end surfaces thereof are engaged;

FIG. 4 is a longitudinal section of first and second tubular workpieces in which devices are positioned inside the tubular workpieces, for directing the preselected material onto heated portions of the workpieces after engagement thereof; and

FIG. 5 is a longitudinal section of first and second tubular workpieces in which a device is positioned outside the tubular workpieces, for directing the preselected material onto heated portions of the workpieces after engagement thereof.

### DETAILED DESCRIPTION

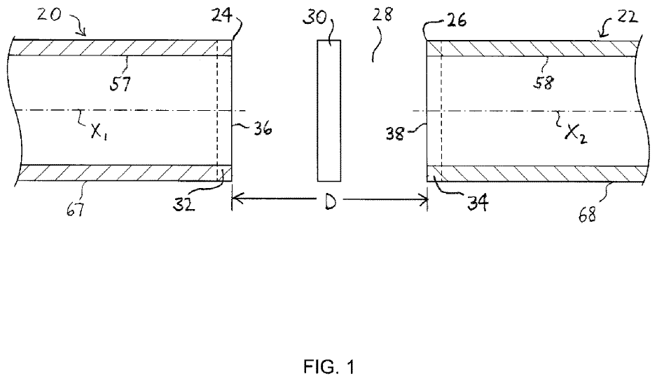

In the attached drawings, like reference numerals designate corresponding elements throughout. Reference is first made to FIGS. 1-3 to describe an embodiment of a method in accordance with the disclosure. As will be described, the method of the disclosure is for joining a first workpiece 20 and a second workpiece 22 together at respective first and second ends 24, 26 thereof.

In the example illustrated in FIGS. 1-3, the workpieces 20, 22 are tubes or pipes made of any metals that are suitable for being joined together such as, but not limited to, steel or steel metal alloys.

As can be seen in FIG. 1, the first and second workpieces 20, 22 are located or positioned a predetermined distance “D” apart from each other such that the end of the first workpiece 20 (seen as the first workpiece end 24) and the end of the second workpiece 22 (seen as the second workpiece end 26) are facing each other. The first and second workpiece ends 24, 26 define a gap 28 therebetween. When required, one or more heating elements 30 are positioned in the gap 28. In the example illustrated in FIG. 1, for clarity of illustration, only one heating element 30 is shown although it is understood that more than one heating element 30 may be used to heat the first and second workpiece ends 24, 26 as will be described in more detail below.

As can also be seen in FIG. 1, the first and second workpieces 20, 22 are initially positioned with their respective axes “X₁”, “X₂” aligned or co-axial with respect to each other, when the workpieces 20, 22 are spaced apart to define the gap 28 therebetween. In the current embodiment, the first and second workpieces 20, 22 are identical metal tubes whereby an internal surface 57 of the first workpiece 20 is aligned with an internal surface 58 of the second workpiece 22, and an external surface 67 of the first workpiece 20 is aligned with an external surface 68 of the second workpiece 22.

When the ends 24, 26 of the workpieces 20, 22 are heated by the at least one heating element 30, the at least one heating element 30 heats a portion of the first workpiece 20 (seen as a first workpiece heated portion 32 or a first heated portion) and a portion of the second workpiece 22 (seen as a second workpiece heated portion 34 or a second heated portion).

In some embodiments, the first and second heated portions 32, 34 of the first and second workpieces 20, 22 are heated by the at least one heating element 30, in an inert atmosphere, to respective hot working temperatures at which the first and second heated portions 32, 34 are plastically deformable. Those skilled in the art would appreciate that the hot working temperature for each workpiece 20, 22 is below the melting temperature of the metal of the workpieces 20, 22. For example, where the workpieces 20, 22 are made of steel, the hot working temperature may be between approximately 1,150 °C and approximately 1,350 °C

The inert atmosphere may include any suitable non-oxidizing gas or gases. The inert atmosphere may be held in place by a container (not shown). Those skilled in the art would be aware of suitable non-oxidizing gases and suitable containers for containing the inert atmosphere. The container for the non-oxidizing gases has been omitted from the drawings for clarity of illustration.

As will be described, the first and second heated portions 32, 34 extend from respective first workpiece and second workpiece end surfaces 36, 38 into the respective first and second workpieces 20, 22. As can be seen in FIG. 1, the end surfaces 36, 38 are exposed at the respective ends 24, 26 of the workpieces 20, 22.

Upon the heated portions 32, 34 reaching their respective hot working temperatures, the at least one heating element 30 is withdrawn from the gap 28. A preselected material “M” (such as in the form of nanoparticles of the preselected material “M”) is then distributed onto the end surfaces 36, 38, and the end surfaces 36, 38 are then engaged with each other and sheared, while the heated portions 32, 34 are at their hot working temperatures. In some embodiments, the preselected material “M” is distributed directly onto the end surfaces and in other embodiments, the preselected material “M” is in suspension between the end surfaces but comes into direct contact with the end surfaces as they are engaged with each other.

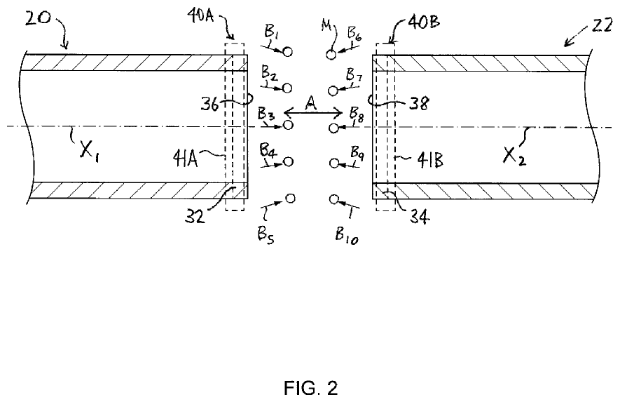

In practice, the heated portions 32, 34 are very narrow but for clarity of illustration, the sizes of the heated portions 32, 34 are exaggerated in FIGS. 1 and 2.

The heating element 30 may be any heating element suitable for heating the heated portions 32, 34 to their respective hot working temperatures. For example, the at least one heating element 30 may be configured for heating the heated portions 32, 34 by induction, when the at least one heating element 30 is energized.

As described above, while the first and second heated portions 32, 34 are at their hot working temperatures, a predetermined quantity of the preselected material “M” is directed from devices 40A, 40B onto the first and second end surfaces 36, 38 (FIG. 2). The devices 40A, 40B may be located inside or outside the workpieces 20, 22.

In some embodiments, the devices 40Aa, 40B may be one or more heat sensitive thin membrane pouches with the preselected material “M” stored within. In use, the pouches may burst depending on any one of timing, a predetermined temperature, in response to a motion or any other known methodologies. In other embodiments, the membranes pouches may be pressurised whereby when they burst, the particles or nanoparticles of the preselected material “M” are distributed around the weld or weldment between the two workpieces. In some embodiments, the pouches may be directed to burst in a predetermined direction. In some embodiments, the pouch may be a continuous container or ring that surrounds the workpieces.

As can be seen in FIG. 2, in one embodiment, the preselected material “M” is distributed on the respective end surfaces 36, 38 before they are engaged with each other.

As will be described, different materials “M” may be considered based on their properties such that the addition of the preselected material “M” enhances or adds to the characteristics of the metal of the workpieces 20, 22 at the first and second end surfaces 36, 38 and/or to the weld between the first and second end surfaces 36, 38. Examples of characteristic enhancements include, but are not limited to, changing a chemistry of the connection or weld between the workpieces; improving a weld seam between the workpieces; providing a physical additive to the weld between the workpieces; increasing a hardness of the weld seam between the workpieces; and/or improving a durability of the weld seam between the workpieces. Examples of materials that may be selected for the preselected material “M” include, but are not limited to, carbon, manganese, phosphorus, sulfur, silicon and the like.

While the heated portions are at their hot working temperatures and after the addition or distribution of the preselected material “M”, the end surfaces 36, 38 are urged against each other, while one or both of the workpieces are subjected to an engagement motion. In some embodiments, one of the workpieces may be held stationary while the other workpiece is urged towards the stationary workpiece via an engagement motion and in other embodiments, both workpieces are urged towards each other via an engagement motion. In some embodiments, the engagement motion may be seen as a rotational motion or movement.

Due to the engagement motion, the heated portions 32, 34 (which are plastically deformable when at their respective hot working temperatures) are subjected to shearing. Preferably, the heated metal in the heated portions 32, 34 of the end surfaces 36, 38 and the preselected metal “M” are at least partially combined in these conditions to form one or more alloys on the end surfaces 36, 38.

It will be understood that the preselected material “M” may be provided in any suitable form. In some embodiments, the preselected material “M” is provided in a relatively fine powder whereby the nanoparticles of the preselected material are relatively small (preferably, as fine as is practicable) in order that the collective surface area of the preselected material that is available for reaction with the metal in the heated portions 32, 34 of the workpieces 20, 22 is maximized or increased.

It will also be understood that only a few particles of the preselected material “M” are shown in FIG. 2, at an exaggerated size, for clarity of illustration. In practice or operation, a very large number of small particles are distributed or directed by the devices 40A, 40B onto the end surfaces 36, 38.

One example of the distribution of the preselected material “M” onto the end surfaces 36, 38 is schematically represented by arrows “B₁” “B₁₀” in FIG. 2. Alternatively, the preselected material “M” may be distributed onto only one of the end surfaces 36, 38 prior to engagement of the end surfaces 36, 38 with each other, while the heated portions 32, 34 are at their hot working temperature or temperatures if the workpieces 20, 22 are made from different materials.

Those skilled in the art would appreciate that the preselected material “M” may be distributed onto either or both of the end surfaces 36, 38 in any suitable manner. For instance, in one embodiment, the preselected material “M” may be provided by the devices 40A, 40B, which are configured to direct the preselected material “M” therein onto a preselected one of the end surfaces 36, 38 upon a predetermined event taking place. Examples of predetermined events may include, but are not limited, the devices reaching a predetermined temperature or the devices being burst during a predetermined sequence.

In at least one embodiment, the devices 40A, 40B are configured to distribute the preselected material “M” therein onto at least one of the end surfaces 36, 38 immediately upon the withdrawal of the at least one heating element 30 from the gap 28, which may also be seen as a predetermined event.

The devices 40A, 40B may have any suitable form, and release of the preselected material “M” therefrom may be effected by any suitable means. As an example, when the devices 40A, 40B are pouches, the devices 40A, 40B may have hollow bodies 41A, 41B containing suitable gases and the preselected material “M” therein, in powder form. Each of the bodies 41A, 41B may include a panel (not shown) that is formed so that the panel fails upon a predetermined event happening (such as the panel reaching a predetermined temperature). Upon failure of the panel within the body of the pouch, the preselected material “M” may be explosively released from the body 41A, 41B toward the end surface opposite or proximate to the device. The explosive release may be due to the gas or gases in the body reaching a suitable or predetermined temperature, and consequently exerting outwardly-directed pressure against the panel for a predetermined time period, until the panel fails or breaks, to enable the preselected material “M” to be propelled by the hot gases toward the end surface positioned opposite. In other embodiments, the devices 40A, 40B may be jets that propel the preselected “M” towards the at least one end surfaces.

In an alternative embodiment, the failure of the body (and the consequent release of the preselected material “M”) may be caused by an electronically controlled rupture of the body 41A, 41B, due to electronic devices (not shown) mounted to the bodies 41A, 41B.

In the example illustrated in FIG. 2, the devices 40A, 40B are positioned adjacent to the gap 28, in order to distribute the preselected material “M” onto the end surfaces 36, 38, however, the devices 40A, 40B may be positioned in other locations while still being able to direct the preselected material “M” towards the end surfaces 36, 38 of the workpieces. For example, the devices may be positioned on an outside of the workpieces; the devices may be positioned on opposite sides of the workpieces; or the devices may be in a concentrated area to selectively focus the preselected material at a specific area.

When the preselected material “M” is distributed onto the end surfaces 36, 38 shortly before they are engaged with each other, the preselected material combines with a small portion of the metal within the heated portions 32, 34 of the end surfaces 36, 38 to form a predetermined or preselected alloy. Based on the material properties of the preselected material “M”, the predetermined alloy includes desirable or known properties. As noted above, the one or more alloys are formed when (i) the metal of the workpieces at the end surfaces 36, 38 and (ii) the preselected material “M” distributed thereon are subjected to plastic deformation, while the heated portions are at their hot working temperature or temperatures. In some embodiments, the deformation of the preselected material “M” may be seen as a movement of atoms made from the material “M” within the weld seam.

Those skilled in the art would be aware of suitable preselected materials that, when combined with the metal of the workpiece(s), form one or more predetermined or preselected alloys having improved properties. As an example, if the workpieces are made of carbon steel, the preselected material may be titanium or an alloy thereof in order to strengthen the metallurgical bond or weld to be formed.

Where the workpieces 20, 22 are made of steel, for example, the preselected material “M” may be carbon, nickel, manganese, silicon, chromium, or molybdenum or alloys of carbon, nickel, manganese, silicon, chromium, or molybdenum. Those skilled in the art would also appreciate that the workpieces 20, 22 may be made of any other material, e.g., a metal or alloy other than steel.

It will be understood that a very thin layer (not shown) of the preselected alloy or alloys is formed on the end surfaces 36, 38 when the end surfaces 36, 38 are urged together and the workpieces 20, 22 are subjected to the engagement motion. For instance, the layer of preselected alloy formed in this way may be only 0.1 nanometers in thickness.

In practice, the layer of the preselected alloy that is thus created may be discontinuous over the end surfaces 36, 38, e.g., because distribution of the preselected material may not be uniform over the end surfaces 36, 38. The predetermined quantity is selected to be sufficient to provide at least a minimum or predetermined layer or size of the preselected alloy sought over a selected area of the end surfaces 36, 38. Those skilled in the art would appreciate that the extent of the layer needed may depend on the intended application of a unit resulting from the process of joining the workpieces.

In other embodiments, depending on the circumstances, the at least one heating element 30 may be removed from the gap 28 before or after the preselected material is distributed onto the end surfaces 36, 38. As noted above, once the first and second heated portions 32, 34 have been heated to their hot working temperatures, the at least one heating element 30 is removed from the gap 28.

Next, while the first and second heated portions 32, 34 are at their hot working temperatures, and after the preselected material is distributed onto the end surfaces 36, 38, one or both of the first and second workpieces 20, 22 are subjected to a translocation motion, to engage the first and second end surfaces 36, 38 with each other. The direction of the translocation motion of one or both of the workpieces 20, 22 is schematically indicated by arrow “A” in FIG. 2.

From the foregoing, it can be seen that at this point in the process of the disclosure, the preselected material is located on the end surfaces 36, 38, and is positioned to be ground or absorbed into the metal in the heated portions 32, 34 at the end surfaces of the workpieces 20, 22 and at least partially mixed with such metal, when one or both of the workpieces are subjected to the engagement motion. The mixing of the preselected material “M” and the metal of the end surfaces (or heated portions) results in the creation of the preselected or predetermined alloy.

Also, while the first and second heated portions 32, 34 are at their hot working temperatures, upon engagement, the first and second end surfaces 36, 38 are urged against each other, generally in the direction of the translocation motion, to keep them engaged with each other. As will be described, once the engagement motion ceases, then the workpieces 20, 22 are bonded together, and they are at that point no longer urged against each other.

While the first and second heated portions 32, 34 are at their hot working temperatures, and while the first and second end surfaces 36, 38 are engaged with each other and urged together, one or both of the first and second workpieces 20, 22 are subjected to the engagement motion, in which one or both of the first and second workpieces 20, 22 are subjected to relative movement thereof, for metallurgically bonding the first and second workpieces 20, 22 together.

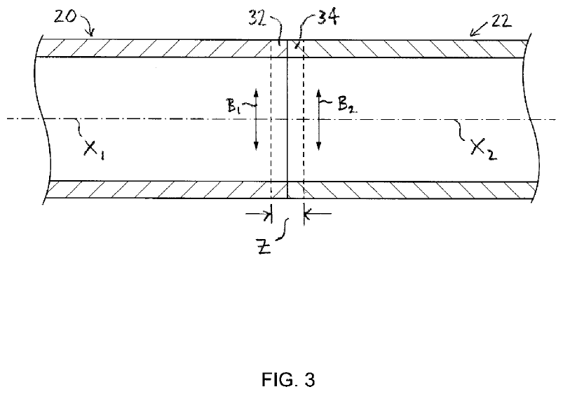

The engagement motion may be any suitable motion of one or both of the first and second workpieces 20, 22 relative to the other. For example, the engagement motion may be any rotation of one or both of the workpieces 20, 22 about their respective axes “X₁”, “X₂” that results in relative motion thereof. As an example, the first workpiece 20 may be rotated about its axis “X₁”, as indicated by arrow “B₁” in FIG. 3. Alternatively, or in addition, the second workpiece 22 may be rotated about its axis “X₂”, as indicated by arrow “B₂” in FIG. 3 while the first workpiece 20 is being rotated or while the first workpiece is stationary.

From the foregoing, it can be seen that the heated portions are at their hot working temperature, and therefore plastically deformable, while the end surfaces 36, 38 are engaged and the workpieces 20, 22 are subject to the engagement motion. The engagement motion causes the plastically deformable material in the first and second heated portions 32, 34 to be subjected to shearing, and to be plastically deformed. The plastically deformed materials, which include the preselected alloy (to a limited extent), form a bonded zone “Z” of metallurgically bonded material across the end surfaces 36, 38 which has a generally uniform microstructure. Preferably, the end surfaces 36, 38 are at least partially subsumed in the bonded zone “Z” of metallurgically bonded material. It will be understood that the extent of the bonded zone “Z” as illustrated in FIG. 3 has been exaggerated for clarity of illustration.

As noted above, the first and second heated portions 32, 34 are very small, e.g., generally less than about 5 mm deep. The bonded zone “Z” is therefore also very small and may be only a few atoms or molecules wide. As noted above, at least some of the particles of the preselected material “M” react with the metal of the workpieces 20, 22 in the respective heated portions 32, 34 (at the respective surfaces 36, 38) during the engagement motion to form the preselected alloy (a combination of the preselected material and the metal of the workpiece(s)), which has desired characteristics. The result is that, due to the addition of the preselected material, the material in the bonded zone “Z” has more desirable characteristics than it otherwise would have.

In some embodiments, the preselected alloy may not be present in a continuous layer across the bonded zone “Z”. However, it is believed that the preselected alloy improves the properties of the bonded material, even if the preselected alloy is not present in a continuous layer.

In practice, after the at least one heating element has been removed, the temperature of the first and second heated portions rapidly falls below their hot working temperatures. It will be understood that the engagement motion ceases once the temperature of the heated portions is below their hot working temperature, and plastic deformation is not possible. In some embodiments, the engagement motion is performed in relation to a known or measured breaking point of the engagement between the two workpieces. At that point, it is assumed or expected that the metallurgical bond has been formed. Those skilled in the art would appreciate that, once the at least one heating element is removed, the heated portions 32, 34 remain at their hot working temperature for only a relatively short time period, e.g., approximately 2 seconds. Accordingly, the engagement motion may continue for only a short time period.

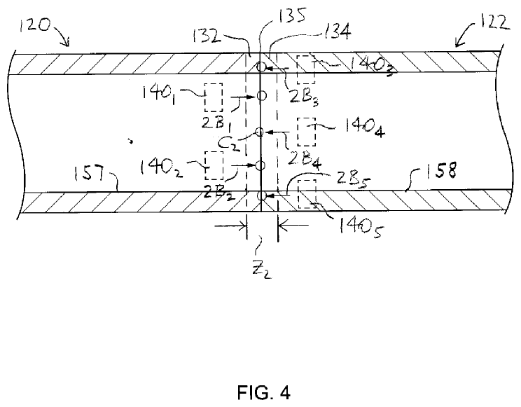

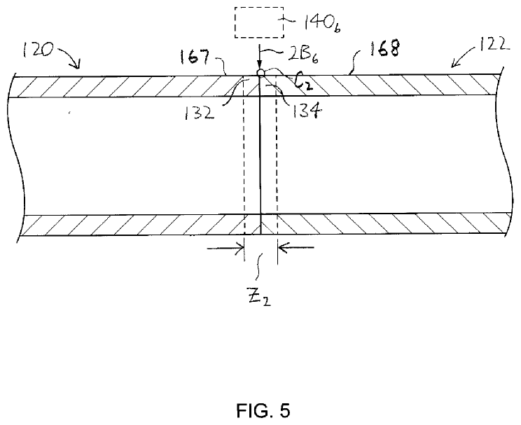

Alternative embodiments of the disclosure are illustrated in FIGS. 4 and 5. In the embodiment illustrated in FIG. 4, a preselected coating material “C₁” is directed onto narrow parts of first and second heated portions 132, 134 along a crease 135 defined between the engaged end surfaces 136, 138 with the first and second heated portion 132, 134 being adjacent to the crease 135, while one or both of the first 120 and second workpieces 122 are subjected to the engagement motion, and/or shortly thereafter. In the examples illustrated in FIGS. 4 and 5, the workpieces 120, 122 are tubes, plates or pipes. In one embodiment, and as illustrated in FIG. 4, the preselected coating material “C₁” is distributed along the crease 135 and on internal surfaces 157, 158 of the workpieces 120, 122 along the parts of the heated portions adjacent to the crease 135, from inside the workpieces 120, 122.

As noted above, although the heated portions of the workpieces are at their hot working temperature or temperatures while one or both of the workpieces are subjected to the engagement motion, the temperature of the heated portions 132, 134 rapidly falls below their hot working temperatures after the at least one heating element is removed. However, those skilled in the art would appreciate that the heated portions may remain at a range of elevated temperatures (i.e., temperatures above ambient temperature), rapidly decreasing to the ambient temperature, for some time after the workpieces have become metallurgically bonded together.

Multiple distribution devices 140₁-140₅ are identified in FIG. 4 for distribution of the preselected coating material “C₁”. One embodiment of the distribution of the preselected coating material “C₁” is schematically represented by arrows “2B₁”-“2B₅” in FIG. 4.

The preselected coating material “C₁” may be any suitable coating material for forming a coating inside the workpieces. The coating may be, for example, formulated to resist or reduce corrosion (by at least partially covering the metal of the workpiece), or formulated to resist or reduce abrasion. Those skilled in the art would be aware of suitable coating materials for the interior of the pipe or tube.

In other embodiments, the preselected coating material “C₁” may be selected for its anti-corrosion properties. Alternatively, or in addition, the preselected coating material “C₁” may be selected for anti-abrasion properties.

In some embodiments, the preselected coating material “C₁” is provided in powdered form or in any other suitable form, and distributed onto selected portions or areas of the workpieces that are at an elevated temperature where the elevated temperature of the selected portions of the workpiece is above the melting temperature of the preselected coating material “C₁” at the time when the preselected coating material “C₁” is distributed thereon. In one embodiment, the preselected coating material “C₁” dissolves or melts upon its contact with the selected portions, and bonds with the workpieces at the selected portions when the workpieces cool to a temperature below the melting point of the preselected coating material “C₁”.

The distribution devices may be any suitable devices. It will be understood that, in one embodiment, one relatively large distribution device instead of multiple small devices 140 may be utilized, e.g., to distribute the preselected coating material “C₁” around the entire internal circumference of the crease 135, onto preselected target areas, i.e., the parts of the heated portions that are adjacent to the crease 135. The distribution devices are configured to distribute the preselected coating material “C₁” generally evenly over the preselected target areas on the internal surfaces 157, 158.

It will be understood that distributing the preselected coating material “C₁” onto the crease and parts of the heated portions adjacent thereto at a time when the respective portions of the workpieces 120, 122 are still relatively warm (i.e., at the elevated temperatures, only slightly below the hot working temperature) can be advantageous. For instance, if the preselected coating material “C₁” is distributed when the respective portions receiving such material are at an elevated temperature above the melting point of the preselected coating material “C₁”, then the preselected coating material “C₁” melts upon its distribution, and no additional heat energy inputs are needed at that point.

The workpieces are thereafter allowed to cool to a temperature below the melting point of the preselected coating material “C₁”, at which the coating formed thereby solidifies on the internal surfaces 157, 158.

Alternatively, or in addition, a preselected coating material “C₂” may be distributed from outside the engaged workpieces 120, 122 onto target areas on external surfaces 167, 168 thereof, as shown in FIG. 5. In the embodiment illustrated in FIG. 5, the preselected coating material “C₂” is distributed onto preselected external target areas, on external surfaces 164, 166 of the workpieces 120, 122.

For clarity of illustration, only one distribution device 140₆ is shown in FIG. 5. The distribution of the preselected coating material “C₂” is schematically represented by arrow “2B₆”.

It will be understood that the sizes of the particles of the preselected coating materials “C₁”, “C₂” as illustrated in FIGS. 4 and 5 are exaggerated for clarity of illustration. Also, although only a few such particles are illustrated in FIGS. 4 and 5, it will be understood that a larger number of particles of the preselected coating materials “C₁”, “C₂” are distributed.

It will be understood that the same preselected coating material may be applied inside and outside the workpieces. In one embodiment, preselected coating material is applied externally only, and in alternative embodiments, preselected coating material may be applied internally only, or both internally and externally. Alternatively, different preselected coating materials may be applied to the internal surfaces 157, 158, and to the external surfaces 167, 168.

It will be appreciated by those skilled in the art that the disclosure can take many forms, and that such forms are within the scope of the disclosure as claimed. The scope of the claims should not be limited by the preferred embodiments set forth in the examples, but should be given the broadest interpretation consistent with the description as a whole.

We claim:

1. A method of joining a first workpiece and a second workpiece comprising:
positioning an end of the first workpiece and an end of the second workpiece a predetermined distance apart from each other, the end of the first workpiece and the end of the second workpiece defining a gap therebetween;
heating respective first and second heated portions of the first and second workpieces, in an inert atmosphere, to their hot working temperature;
while the first and second heated portions are at their hot working temperature, directing a predetermined quantity of a preselected material onto at least one of the end of the first workpiece and the end of the second workpiece;
while the first and second heated portions are at their hot working temperature, subjecting one or both of the first and second workpieces to a translocation motion, to engage the end of the first workpiece with the end of the second workpiece with each other; and
while the first and second heated portions are at their hot working temperature, and while the end of the first workpiece and the end of the second workpiece are engaged, subjecting one or both of the first and second workpieces to an engagement motion, in which said one or both of the first and second workpieces are subjected to relative movement thereof, for metallurgically bonding the first and second workpieces together.

2. The method of claim 1 wherein heating respective first and second heated portions of the first and second workpieces, in an inert atmosphere, to their hot working temperature comprises:
locating at least one heating element in the gap between the end of the first workpiece and the end of the second workpiece; and
energizing the at least one heating element.

3. The method of claim 2 wherein heating respective first and second heated portions of the first and second workpieces, in an inert atmosphere, to their hot working temperature further comprises:
removing the at least one heating element from the gap between the end of the first workpiece and the end of the second workpiece.

4. The method of claim 1 wherein directing a predetermined quantity of a preselected material onto at least one of the end of the first workpiece and the end of the second workpiece comprises:
directing particles of the preselected material at at least one end of the first workpiece and the end of the second workpiece.

5. The method of claim 1 wherein directing a predetermined quantity of a preselected material onto at least one of the end of the first workpiece and the end of the second workpiece comprises:
directing a coating at at least one of the end of the first workpiece and the end of the second workpiece.

6. The method of claim 5 wherein directing a coating at at least one of the end of the first workpiece and the end of the second workpiece comprises:
directing the coating at inner surfaces of at at least one of the first or second workpieces.

7. The method of claim 5 wherein directing the coating at inner surfaces of at at least one of the first or second workpieces comprises:
directing the coating at first and second heated portions of the first and second workpieces.

8. The method of claim 1 further comprising, after subjecting the first and second workpieces to the translation motion:
urging the end of the first workpiece and the end of the second end workpieces each other.

9. The method of claim 1 wherein the engagement motion is a rotational motion.
